(19) United States
(12) Patent Application Publication
(10) Pub. No.: US 2025/0353169 A1
(43) Pub. Date: Nov. 20, 2025

(54) SEMI-SUPERVISED LEARNING OF ROBOT CONTROL POLICIES

(71) Applicant: GDM Holding LLC, Mountain View, CA (US)

(72) Inventors: Guangyao Zhou, Newark, CA (US); Rajkumar Vasudeva Raju, San Jose, CA (US); Sivaramakrishnan Swaminathan, Mountain View, CA (US); J. Swaroop Guntupalli, San Jose, CA (US); Miguel Lázaro-Gredilla, Union City, CA (US); Kevin Patrick Murphy, Palo Alto, CA (US)

(21) Appl. No.: 19/206,894

(22) Filed: May 13, 2025

Related U.S. Application Data
(60) Provisional application No. 63/649,894, filed on May 20, 2024.
(60) Provisional application No. 63/650,828, filed on May 22, 2024.

(51) Int. Cl. B25J 9/16

(52) U.S. Cl. CPC B25J 9/163; B25J 9/1664

(57) ABSTRACT

Implementations are provided for leveraging training data that is less costly to collect than state-action sequences to perform semi-supervised training of robot control policies. In various implementations, a first input prompt may be assembled with representations of an observed initial state of a robot and a goal state of the robot. The first input prompt may be processed using a goal-conditioned trajectory model to generate first output indicative of a sequence of predicted states to be reached by the robot between the observed initial and goal states. A second input prompt may be assembled to include representations of the sequence of predicted states. The second input prompt may be processed using an action prediction model to generate second output indicative of a sequence of predicted actions to be performed by the robot to reach the sequence of predicted states.

### BACKGROUND

Diffusion policies can be used in the robotics domain to represent the distribution over a next sequence of actions. Given a goal and a previous context, a diffusion policy may be generated/predicted by learning p(a_{t+1:t+F}|s_{0:t}, a_{1:t}, g) (F represents a forecast horizon or chunk frequency) using various types of machine learning models, such as diffusion models. This approach may work well for high-dimensional control tasks such as robot grasping given visual input. However, these diffusion models are typically trained using expert trajectory data in which the state sequence is accompanied by a corresponding action sequence, D_{SA}-{(sₜ, aₜ): t=1: T}. Gathering this type of training data can be challenging, e.g., due to costs associated with teleoperating a robot.

### SUMMARY

Implementations described herein allow for leveraging training data that is less costly to collect than expert-gathered state-action sequences to perform semi-supervised training of machine learning models such as diffusion models and/or flow models. These trained models may then be used, for instance, to predict/generate diffusion policies for controlling robots. In general, techniques described herein formulate prediction of robot control policies as first asking “what will the future look like, expressed in terms of a future sequence of predicted states of a robot and/or its environment, given a current and goal states of the robot and/or its environment?” Techniques then ask, “what actions should the robot perform to reach the sequence of predicted states?”

In various implementations, a method may be implemented using one or more processors and may include: assembling, as a first input prompt, representations of an observed initial state of a robot and a goal state of the robot; processing the first input prompt using a goal-conditioned trajectory model to generate first output indicative of a sequence of predicted states to be reached by the robot between the observed initial and goal states; assembling, as a second input prompt, representations of the sequence of predicted states; and processing the second input prompt using an action prediction model to generate second output indicative of a sequence of predicted actions to be performed by the robot to reach the sequence of predicted states.

In various implementations, the method may include training a diffusion policy for controlling one or more robots based on the sequences of predicted states and predicted actions. In various implementations, the goal-conditioned trajectory model may be trained using reference sequences of previously observed robot states, wherein for each reference sequence of previously observed robot states, each previously observed robot state may be annotated based on a final previously observed robot state of the reference sequence.

In various implementations, the goal-conditioned trajectory model may be a diffusion model. In various implementations, the goal-conditioned trajectory model may be a flow model. In various implementations, the representation of the goal state of the robot may include one or more synthetic digital images depicting the goal state. In various implementations, the representation of the goal state of the robot may include a set of reference points on the robot that collectively represent the goal state.

In various implementations, the representation of the goal state of the robot may include a representation of the robot itself in the goal state. In various implementations, the representation of the goal state of the robot may include a representation of a human or different robot in a pose that corresponds to the goal state of the robot.

In various implementations, the method may include: prior to assembling the first input prompt, assembling, as a third input prompt, representations of the observed initial state of a robot and a task to be performed by the robot; and processing the third input prompt using a generative model to generate the representation of the goal state.

In various implementations, the method may include generating a control signal for controlling one or more robots based on one or more of the sequence of predicted actions. In various implementations, the method may include operating one or more robots based on one or more of the sequence of predicted actions.

In various implementations, the method may include generating a first control signal for controlling the robot based on a subset of one or more predicted actions selected from the sequence of predicted actions. In various implementations, the method may include: assembling, as a third input prompt, a representation of a subsequent observed state of the robot upon the robot being controlled based on the first control signal; processing the third input prompt using the goal-conditioned trajectory model to generate third output indicative of a subsequent sequence of predicted states to be reached by the robot after the subsequent observed state; assembling, as a fourth input prompt, representations of the subsequent sequence of predicted states to be reached by the robot after the subsequent observed state; and processing the fourth input prompt using the action prediction model to generate fourth output indicative of a subsequent sequence of predicted actions to be performed by the robot to reach the subsequent sequence of predicted states.

In various implementations, the method may include generating a control signal for controlling the robot based on a new subset of predicted actions selected from the subsequent sequence of predicted actions. In various implementations, the fourth input prompt may be further assembled to include a representation of the subsequent observed state of the robot upon the robot being controlled based on the first control signal.

In various implementations, the second input prompt may be further assembled to include a representation of the observed initial state of a robot.

In another aspect, a method may be implemented using one or more processors and may include: assembling, as a first input prompt, representations of an observed initial state of a robot and a goal state of the robot; processing the first input prompt using a goal-conditioned trajectory model to generate first output indicative of an interpolated sequence of predicted states to be reached by the robot between the observed initial and goal states; assembling, as a second input prompt, representations of the interpolated sequence of predicted states; and processing the second input prompt using an action prediction model to generate second output indicative of an interpolated sequence of predicted actions to be performed by the robot to reach the interpolated sequence of predicted states.

In various implementations, the method may include training a diffusion policy for controlling one or more robots based on the interpolated sequences of predicted states and predicted actions. In various implementations, the goal-conditioned trajectory model may be trained using reference sequences of previously observed robot states, wherein for each reference sequence of previously observed robot states, each previously observed robot state is annotated based on a final previously observed robot state of the reference sequence. In various implementations, the goal-conditioned trajectory model may include a diffusion model. In various implementations, the goal-conditioned trajectory model may include a flow model.

In another aspect, a method may be implemented using one or more processors and may include: collecting a reference sequence of previously observed states of a kinematic entity; annotating each previously observed state of the kinematic entity based on a selected previously observed state of the kinematic entity in the reference sequence; assembling, as an input prompt, representations of an observed initial state of the kinematic entity and the selected previously observed state of the kinematic entity in the reference sequence; processing the input prompt using a trajectory model to generate output indicative of an interpolated sequence of predicted states to be reached by the kinematic entity between the observed initial state and the selected previously observed state of the kinematic entity in the reference sequence; comparing the sequence of predicted states to the reference sequence of previously observed states; and adapting the trajectory model based on the comparing.

In various implementations, the selected previously observed state of the kinematic entity may be the final previously observed state of the kinematic entity in the reference sequence. In various implementations, the kinematic entity may include a robot. In various implementations, the kinematic entity may be a human. In various implementations, the reference sequence of previously observed states may include a video captured of the kinematic entity. In various implementations, the reference sequence of previously observed states may include a trajectory of reference points of the kinematic entity over time.

Several implementations described herein relate to methods for performing selected aspects of the present disclosure. Other implementations may include a non-transitory computer readable storage medium storing instructions executable by a processor to perform a method such as one or more of the methods described herein. Yet another implementation may include a control system including memory and one or more processors operable to execute instructions, stored in the memory, to implement one or more modules or engines that, alone or collectively, perform a method such as one or more of the methods described herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 schematically depicts an example environment in which selected aspects of the present disclosure may be implemented.

FIG. 2 schematically depicts an example robot.

FIG. 3 schematically depicts an example method for carrying out selected aspects of the present disclosure.

FIG. 4 schematically depicts another example method for carrying out selected aspects of the present disclosure.

FIG. 5 schematically depicts another example method for carrying out selected aspects of the present disclosure.

FIG. 6 schematically depicts an example computer architecture.

### DETAILED DESCRIPTION

Implementations described herein allow for leveraging training data that is less costly to collect than expert-gathered state-action sequences to perform semi-supervised training of machine learning models such as diffusion models and/or flow models. These trained models may then be used, for instance, to predict/generate diffusion policies for controlling robots. In general, techniques described herein formulate prediction of robot control policies as first asking “what will the future look like, expressed in terms of a future sequence of predicted states of a robot and/or its environment, given a current and goal states of the robot and/or its environment?” Techniques then ask, “what actions should the robot perform to reach the sequence of predicted states?”

More particularly, but not exclusively, implementations are described herein for using state sequences D_{S}={sₜ: t=1: T} without corresponding action labels to train a goal-conditioned trajectory model p(ŝ_{t+iT}|sₜ, g) that that predicts/generates output indicative of a sequence of predicted states ŝ_{t+1:T} to be reached by a robot between an observed initial state sₜ and a goal state g. The goal-conditioned trajectory model may be implemented in various forms, such as a diffusion model and/or a flow model.

In some implementations, this sequence of predicted states may be processed using an action prediction model to generate output indicative of a one or more predicted actions to be performed by the robot to reach the sequence of predicted states. The action prediction model may be implemented in various forms as well, such as a diffusion model and/or a flow model. In some implementations, the action prediction model may be formulated as an inverse dynamics model p(aₜ₊₁|sₜ, ŝₜ₊₁) that can be applied iteratively/repeatedly to the sequence of predicted states to predict one action at a time. In other implementations, the action prediction model may be formulated as p(a_{t+1:t+F}|s_{0:t}, ŝ_{t+1:t+F′}), where ŝ_{t+1:t+F′} is sampled from p(s_{t+1:T}|s_{0:t}, g), such that it can be applied to generate/predict sequences of multiple predicted actions at once.

In some implementations, these sequences of predicted states and accompanying sequences of predicted actions can be used for training purposes, such as for training a machine learning model to learn a diffusion policy p(a_{t+1:t+F}|s_{0:t}, a_{1:t}, g) In other implementations, the sequences of predicted actions may be used to control a robot. For example, a control signal may be generated that is then transmitted to a robot to cause the robot to perform one or more actions from the sequence of predicted actions. In some implementations, this control signal may carry (e.g., be modulated to convey) robot control data.

“Robot control data” may include, for instance, low-level actuator commands (also referred to as “joint commands,” and may include torque commands) that directly control the actuators/joints of the robot, cartesian commands that specify direction(s) for an end effector, a target robot pose, code that specifies reward functions that a motion controller can optimize (e.g., using techniques such as receding horizon optimization) to find optimal low-level actuator commands, selected predefined robot primitives, and so forth. In some cases, robot logic may be configured to convert between joint commands and Cartesian commands, e.g., using forward and/or inverse kinematics.

Techniques described herein provide for various technical advantages. Datasets D_{S} containing only state trajectories, without accompanying action labels, can be sampled with relatively little overhead, e.g., by annotating captured video of any kinematic entity taking a series of actions. “Kinematic entities” may broadly refer to various types of robots (e.g., humanoid, bipedal, quadruped, wheeled, etc.), humans, animals, and so forth, and therefore, a large amount of data already exists from which to collect datasets D_{S}. Datasets D_{S} may be sampled from data other than videos as well, such as human demonstrations, animations, simulations, etc. Datasets D_{S} may represent observed states in a variety of different forms, including but not limited digital images, trajectories of reference points of the kinematic entity, other representations of a robot (e.g., robot pose, joint configuration, etc.), and so forth.

Annotating a dataset D_{S} with a final goal to yield

$${D}_{s}^{g}$$

likewise can be accomplished with relatively little overhead. In some implementations, hindsight relabeling may be performed in which each state is annotated with a goal g. A goal g may be arbitrarily defined as any state of the trajectory, such as a final state of the trajectory or any state downstream of the initial state.

Additionally, a non-causal policy model p(a_{t+1:t+F}|past, future) may require less computational resources, data, and/or time to train compared to, for instance, a purely causal diffusion policy p(a_{t+1:t+F}|past). This may be attributable to the former being more akin to interpolation whereas the latter is more akin to extrapolation. Moreover, techniques described herein are usable to generate sequences of multiple predicted actions. This may provide advantages relative to iteratively generating one action at a time, which can be slow due to its sequential nature, myopic because it only conditions on the next state, and/or can cause “action jitter.”

Diffusion models trained using disclosed techniques may be used for robot planning in a variety of ways, depending on how the diffusion policy p(aₜ₊₁|hₜ) is represented (hₜ is the history of previously observed states and actions, as well as the relevant training set). Some planning frameworks use diffusion policies that directly learn p(a_{t+1:t+F}|hₜ). A diffuser model, by contrast, predicts the joint (state, action) distribution into the future, p(s_{t+1:T}, a_{t+1:T}|hₜ), and then extracts the marginal action p(aₜ₊₁|hₜ), takes the extracted marginal action, and then replans. A decision diffuser-based planning framework predicts the state distribution into the future, p(s_{t+1:T}|hₜ), then derives the marginal action p(aₜ₊₁|sₜ, sₜ₊₁), using an inverse dynamics model, takes the derived marginal action, and replans.

In some implementations configured with selected aspects of the present disclosure, a state distribution may be predicted into the future, p(s_{t+1:T}|hₜ) using the aforementioned goal-trajectory model. In some such implementations, a synthetic representation of the goal state may also be generated, e.g., on-the-fly using a diffusion model to generate a synthetic image of the goal state, and processed as an additional input to further condition generation of the state distribution into the future.

Next, a joint action sequence p(a_{t+1:t+F}|sₜ, . . . , s_{T}). may be derived/predicted/generated using the aforementioned action prediction model. A sequence (e.g., subset) of the predicted actions may be performed, e.g., by a real or simulated robot, and then the planning process may repeat. Put another way, techniques described herein may be implemented in accordance with the following equation for planning:

$${P}_{λ} ( {\hat{s}}_{t + 1 : t + F} , \vert {s}_{1 : t} , g , {D}_{s}^{g} ) p ( {a}_{t + 1 : t + F} \vert {s}_{1 : t} , {a}_{1 : t} , {\hat{s}}_{t + 1 : t + F} , {D}_{s a} )$$

where p_{λ} represents classifier-free guidance.

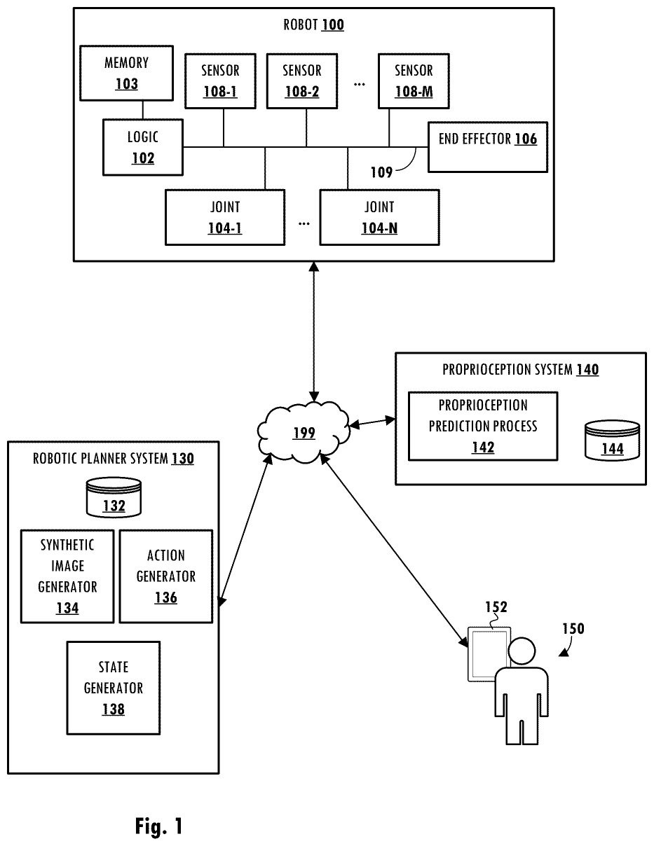

FIG. 1 is a schematic diagram of components that can cooperate to carry out selected aspects of the present disclosure, in accordance with various implementations. The various components depicted in FIG. 1, particularly those components forming a robotic planner system 130 and a proprioception system 140, may be implemented using any combination of hardware and software. The components of FIG. 1 are depicted as being communicatively coupled with each other via one or more networks 199, which may include one or more personal area networks, local area networks, and/or wide area networks (e.g., the Internet). However, this is not meant to be limiting. Various aspects of the present disclosure that are described as being performed by and/or stored on systems 130 and/or 140 can alternatively be performed by and/or stored on a single system, such as robot planner system 130, or on any combinations of systems 130 and 140.

In some implementations, techniques described herein may be used to control various types of machines or apparatus. For example, in some implementations, a robot 100 may be in communication with systems 130 and/or 140. In various implementations, and/or all or parts of systems 130 and/or 140 may be implemented onboard robot 100. Other types of machines or apparatus that are not depicted in FIG. 1 may also be controlled using selected aspects of the present disclosure, such as autonomous vehicles, industrial equipment, climate control systems, medical systems and/or devices, video games, and so forth.

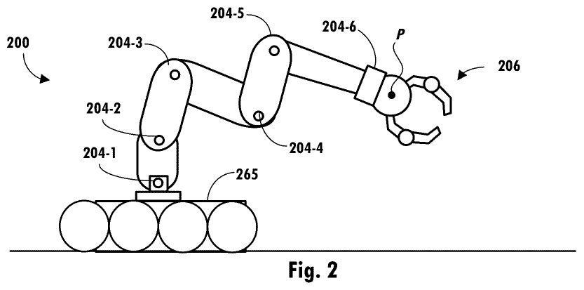

Robot 100 may take various forms, including but not limited to a telepresence robot (e.g., which may be as simple as a wheeled vehicle equipped with a display and a camera), a robot arm, a multi-pedal robot such as a “robot dog,” an aquatic robot, a wheeled device, a submersible vehicle, an unmanned aerial vehicle (“UAV”), and so forth. One non-limiting example of a mobile robot arm is depicted in FIG. 2. In various implementations, robot 100 may include logic 102. Logic 102 may take various forms, such as a real time controller, one or more processors, one or more field-programmable gate arrays (“FPGA”), one or more application-specific integrated circuits (“ASIC”), and so forth. In some implementations, logic 102 may be operably coupled with memory 103. Memory 103 may take various forms, such as random-access memory (“RAM”), dynamic RAM (“DRAM”), read-only memory (“ROM”), Magnetoresistive RAM (“MRAM”), resistive RAM (“RRAM”), NAND flash memory, and so forth. In some implementations, a robot controller may include, for instance, logic 102 and memory 103 of robot 100.

In some implementations, logic 102 may be operably coupled with one or more joints 104-1 to 104-N, one or more end effectors 106, and/or one or more sensors 108-1 to 108-M, e.g., via one or more buses 109. As used herein, “joint” 104 of a robot may broadly refer to actuators, motors (e.g., servo motors), shafts, gear trains, pumps (e.g., air or liquid), pistons, drives, propellers, flaps, rotors, or other components that may create and/or undergo propulsion, rotation, and/or motion. Some joints 104 may be independently controllable, although this is not required. In some instances, the more joints robot 100 has, the more degrees of freedom of movement it may have.

As used herein, “end effector” 106 may refer to a variety of tools that may be operated by robot 100 in order to accomplish various tasks. For example, some robots may be equipped with an end effector 106 that takes the form of a claw with two opposing “fingers” or “digits.” Such a claw is one type of “gripper” known as an “impactive” gripper. Other types of grippers may include but are not limited to “ingressive” (e.g., physically penetrating an object using pins, needles, etc.), “astrictive” (e.g., using suction or vacuum to pick up an object), or “contigutive” (e.g., using surface tension, freezing or adhesive to pick up object). More generally, other types of end effectors may include but are not limited to drills, brushes, force-torque sensors, cutting tools, deburring tools, welding torches, containers, trays, and so forth. In some implementations, end effector 106 may be removable, and various types of modular end effectors may be installed onto robot 100, depending on the circumstances. Some robots, such as some telepresence robots, may not be equipped with end effectors. Instead, some telepresence robots may include displays to render visual representations of the users controlling the telepresence robots, as well as speakers and/or microphones that facilitate the telepresence robot “acting” like the user.

Sensors 108-1 to 108-M may take various forms, including but not limited to 3D laser scanners (e.g., light detection and ranging, or “LIDAR”) or other 3D vision sensors (e.g., stereographic cameras used to perform stereo visual odometry) configured to provide depth measurements, two-dimensional cameras (e.g., RGB, infrared), light sensors (e.g., passive infrared), force sensors, pressure sensors, pressure wave sensors (e.g., microphones), proximity sensors (also referred to as “distance sensors”), depth sensors, torque sensors, barcode readers, radio frequency identification (“RFID”) readers, radars, range finders, accelerometers, gyroscopes, compasses, position coordinate sensors (e.g., global positioning system, or “GPS”), speedometers, edge detectors, Geiger counters, and so forth. While sensors 108-1 to 108-M are depicted as being integral with robot 100, this is not meant to be limiting.

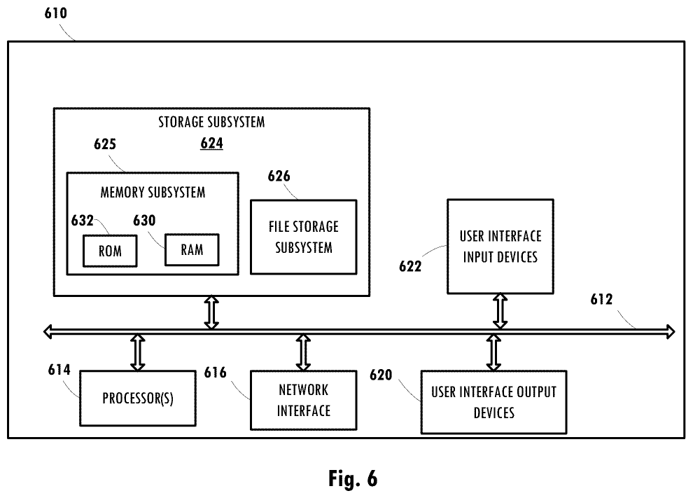

In some implementations, robot planner system 130 and/or proprioception system 140 may include one or more computing devices cooperating to perform selected aspects of the present disclosure. An example of such a computing device is depicted schematically in FIG. 6. In some implementations, one or more of systems 130 and/or 140 may include one or more servers forming part of what is often referred to as a “cloud” infrastructure, or simply “the cloud.” Alternatively, one or more components of systems 130 and/or 140 may be operated by logic 102 of robot 100.

Machine learning and/or generative model(s) described herein may take various forms, including, but not limited to, generative model(s) such as Pathways Language Model (PaLM), Unified language Model (ULM), PaLM-2-E/ULM-E, BERT, LaMDA, Meena, and/or any other generative model, such as diffusion model(s), flow models, any other generative model that is encoder-only based, decoder-only based, sequence-to-sequence based and that optionally includes an attention mechanism or other memory, etc. Generative models and/or diffusion models may have hundreds of millions, or even hundreds of billions of parameters. In some implementations, generative and/or diffusion models may include multi-modal models such as a VLM and/or a visual question answering (VQA) model, which can have any of the aforementioned architectures, and which can be used to process multiple modalities of data, particularly images and text, and/or images and audio for example, to generate one or more modalities of output. Non-limiting examples of VLMs that may be applied as described herein include Gemini and/or Flamingo, to name a few. Another example of a generative model that might be used is described in “RT-2: Vision-Language-Action Models Transfer Web Knowledge to Robotic Control” (arXiv:2307.15818), which is incorporated herein for all purposes.

Robot planner system 130 may include a synthetic image generator 134, an action generator 136, and/or a state generator 138, any of which being operably coupled with one or more generative models 132. Any of generators 134, 136 and/or 136 may be implemented using any combination of hardware and software. Moreover, any of generators 134, 136 and/or 138 may be combined with other(s) of generators 134, 136 and/or 138.

In various implementations, synthetic image generator 134, action generator 136, and/or state generator 138 may be configured to process various modalities of inputs, including but not limited to natural language snippets (e.g., requests, queries, commands, etc.), images, videos, set of reference points, etc., using one or more generative models 132 and generate various modalities of output. In many implementations described herein, natural language input that is processed by synthetic image generator 134, action generator 136, and/or state generator 138 may include a natural language request for robot 100 to perform a high-level task (e.g., “put these dishes into the dishwasher”). Synthetic image generator 134, action generator 136, and/or state generator 138 may process such a natural language request using generative model(s) 132 to generate various types of data, such as a plurality of natural language responses each conveying an action, various types of synthetic images, etc. Each natural language response may express a mid-level action to be performed by robot 100 to carry out a respective portion of the high-level task.

Synthetic image generator 134 may be configured to process various modalities of data, such as natural language, image(s), video, actions, etc., to generate (or predict) one or more synthetic images that depict a robot and/or an environment in which the robot operates in the future. For example, in some implementations, synthetic image generator 134 may assemble, as an input prompt, first data indicative of a natural language command for robot 100 to complete a task, and second data indicative of “real” or “actual” digital image(s) acquired by one or more vision sensors that depict an environment in which the robot operates. Synthetic image generator 134 may then process the input prompt using one or more multimodal generative models 132 (which may take the form of a diffusion model) to generate a synthetic goal image that visualizes a predicted state of the robot and/or a predicted state of the environment upon completion of the task by the robot. Such a model may be trained and/or fine-tuned based on, for instance, recorded episodes of robots being operated to perform tasks that include initial and final images.

Action generator 136 may be configured to process various modalities of data to generate output indicative of action(s) to be performed by robot 100 in furtherance of carrying out the task. For example, in some implementations, action generator 136 may be configured to assemble an input prompt that includes the representations of a sequence of states, e.g., generated by state generator 138 as discussed below. In some implementations, other data may be included in this input prompt as well, such as the natural language command, the synthetic goal image, etc. Action generator 136 may then process the input prompt using one or more of the multimodal generative models (e.g., diffusion or flow model) to predict one or more actions to be performed by the robot in furtherance of completing the task. Actions may be expressed in various ways, such as robot control data, natural language commands, joint trajectories, etc.

State generator 138 may be configured to process various modalities of data to generate output indicative of states to be reached by robot 100 in furtherance of carrying out the task. These states of robot 100 and/or its environment may be represented and/or expressed in various ways, such as images (real or synthetic, as the case may be), sets of references points, robot poses, etc. In some implementations, state generator 138 may be configured to assemble an input prompt that include representations of an observed initial state of robot 100 (e.g., represented in a digital image, set of reference points, etc.) and/or its environment and a goal state of robot 100 and/or its environment. In some implementations, the goal state may have been generated by synthetic image generator 134. State generator 138 may then process the second input prompt using one or more of the multimodal generative models 132 to generate output from which can be derived, for instance, an interpolated sequence of predicted states to be reached by the robot between the observed initial and goal states.

Proprioception system 140 may be present in some implementations where robot 100 is being controlled using techniques described herein. Proprioception system 140 may be omitted in other circumstances. Proprioception system 140 may include a proprioception prediction process 142 and one or more proprioception machine learning models 144. Examples of proprioception machine learning models that may be used are described in “RT-1: Robotics Transformer for Real-World Control at Scale” (arXiv:2212.06817), which is incorporated herein for all purposes, and the aforementioned RT-2 paper.

In various implementations, proprioception prediction process 142 may process input tokens indicative of a current (or past) proprioception values of robot 100, e.g., along with other data such as data indicative of a task or action to be performed, state data of the robot and/or its environment, and/or actions predicted by action generator 136, to generate robot control data and/or predict future proprioception values of robot 100. These robot control data and/or future proprioception values may be used to operate robot 100. In instances where action generator 136 generates actions expressed in natural language, proprioception prediction process 142 may use proprioception machine learning model(s) 144 to translate these actions expressed in natural language into robot control data. In other implementations, generative model(s) used by action generator 136 may be trained to directly generate robot control data and/or future proprioception values, in which case proprioception system 140 may be omitted.

“Robot control data” may include, for instance, low-level actuator commands (also referred to as “joint commands,” and may include torque commands) that directly control the actuators/joints 104-1 to 104-N of the robot, cartesian commands that specify direction(s) for an end effector 106, a target robot pose, code that specifies reward functions that a motion controller can optimize (e.g., using techniques such as receding horizon optimization) to find optimal low-level actuator commands, selected predefined robot primitives, and so forth. In some cases, robot logic 102 may be configured to convert between joint commands and Cartesian commands, e.g., using forward and/or inverse kinematics.

In various implementations, a user 150 may control robot 100 using a client device 152. While depicted as a tablet computer or smartphone in FIG. 1, client device 152 may take other forms, such as a desktop or laptop computer, in-vehicle computing device, augmented reality (AR) and/or virtual reality (VR) headset or glasses, standalone “smart” speakers that host automated assistants that can be interacted with the control robot 100, etc. In various implementations, user 150 may issue one or more natural language commands, e.g., by typing the commands or uttering the commands aloud and having those spoken utterances transcribed using speech-to-text (STT) processing. These natural language commands may specify a task to be completed by robot 100 in an environment in which robot 100 operates. For example, user 150 may ask robot 100 to “pick plate from top drawer and place on counter, and close drawer,” “close the windows,” “take the dishes from the table to the sink,” etc.

FIG. 2 depicts a non-limiting example of a robot 200 in the form of a robot arm. An end effector 206 in the form of a gripper claw is removably attached to a sixth joint 204-6 of robot 200. In this example, six joints 204-1 to 204-6 are indicated. However, this is not meant to be limiting, and robots may have any number of joints. In some implementations, robot 200 may be mobile, e.g., by virtue of a wheeled base 255 or other locomotive mechanism. Robot 200 is depicted in FIG. 2 in a particular selected configuration or “pose.”

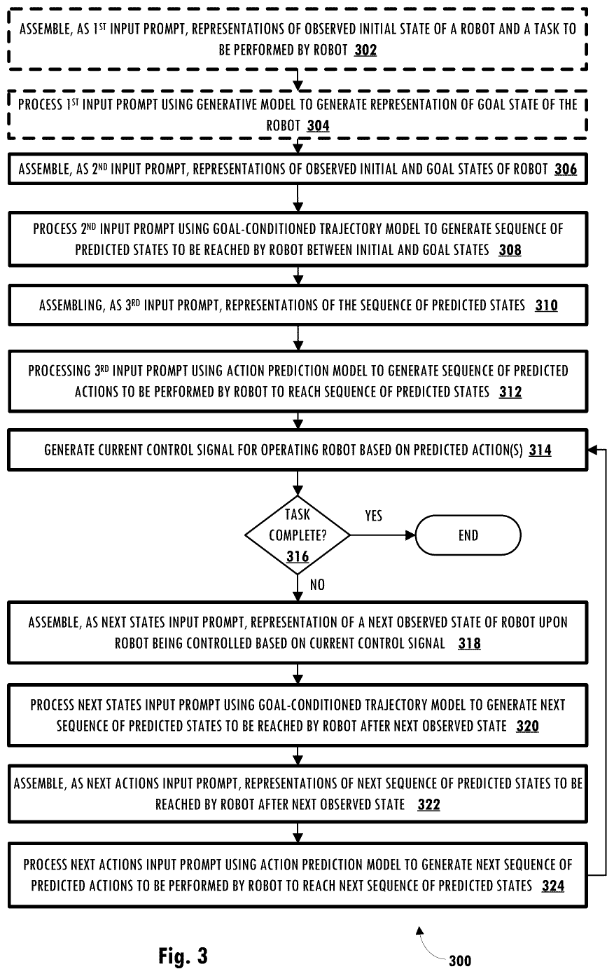

Referring now to FIG. 3, an example method 300 of practicing selected aspects of the present disclosure is described. For convenience, the operations of the flowchart are described with reference to a system that performs the operations. This system may include various components of various computer systems, including those depicted in FIG. 1. Moreover, while operations of method 300 are shown in a particular order, this is not meant to be limiting. One or more operations may be reordered, omitted or added.

At optional block 302, the system may assemble, as a first input prompt, representations of an observed initial state of a robot and/or its environment and a task to be performed by the robot. The task may be initially expressed in various forms, such as natural language, and may be represented in various ways in the first input prompt, such as in the form of one or more embeddings.

At optional block 304, the system, e.g., by way of synthetic image generator 134, may process the first input prompt using a generative model (e.g. 132) to generate a synthetic representation of a goal of the robot and/or its environment. In some implementations, the generative model may be a diffusion model, a flow model, etc. In some implementations, the synthetic representation of the goal may be a digital image that visualizes the robot and/or it is environment in the goal state upon completion of the task. In other implementations, the goal state may be expressed as a set of reference points of the robot, a joint configuration of the robot, a pose of the robot, etc.

At block 306, the system, e.g., by way of state generator 138, may assemble, as a second input prompt, representations of the observed initial state of the robot and/or its environment and the goal state of the robot. If blocks 302-304 were performed, the representation of the goal state may be derived from or include the synthetic representation of the goal state. In some implementations, the second input prompt may also be assembled to include a representation of the task to be performed by the robot, although this is not required.

At block 308, the system, e.g., by way of state generator 138, may process the second input prompt using a goal-conditioned trajectory model (e.g., 132) to generate output indicative of a sequence of predicted (e.g., interpolated) states to be reached by the robot between the observed initial and goal states. As above, each predicted state of this sequence can be represented in various ways, such as an image, set of reference points, robot pose, joint configuration, etc.

At block 310, the system, e.g., by way of action generator 136, may assemble, as a third input prompt, representations of the sequence of predicted states that were generated by state generator at block 308. At block 312, the system, e.g., by way of action generator 136, may process the third input prompt using an action prediction model (e.g., 132) to generate output indicative of a sequence of predicted actions to be performed by the robot to reach the sequence of predicted states. These actions may be expressed in various ways, such as natural language commands, robot control data, etc.

In some, but not all implementations, method 300 may continue. At block 314, the system, e.g., by way of action generator 136 and/or proprioception system 140, may generate what will be referred to as a “current” control signal for controlling one or more real or simulated robots (e.g., 100) based on one or more of the sequence of predicted actions. While not shown in FIG. 3, this current control signal may be used to control a robot, e.g., by being transmitted to the robot and/or to proprioception system, which may in turn generate robot control data for robot 100. Then, at block 316, the system may determine whether the original assigned to the robot has been completed. If the answer is yes, the method 300 may end.

However, if the answer at block 316 is no, then method 300 may proceed to block 318. At block 318, the system may assemble, as a “next states” input prompt, a representation of a next observed state of the robot upon the robot being controlled based on the first control signal. In some implementations, this next states input prompt may also be assembled to include the representation of the goal state that was included in the second input prompt, or a new representation of the goal state if the state of the robot and/or its environment has changed over time.

At block 320, the system, e.g., by way of state generator 138, may process the next states input prompt using the goal-conditioned trajectory model to generate output indicative of what will be referred to as a “next sequence” of predicted states to be reached by the robot after the next (also referred to as a “subsequent”) observed state.

At block 322, the system, e.g., by way of action generator 136, may assemble, as what will be referred to as a “next actions” input prompt, representations of the next sequence of predicted states to be reached by the robot after the subsequent observed state. At block 324, the system, e.g., by way of action generator 136, may process the next actions input prompt using the action prediction model to generate output indicative of what will be referred to as a “next sequence” of predicted actions to be performed by the robot to reach the next sequence of predicted states. Method 300 may then proceed back to block 314, and blocks 314-324 may repeat until, for instance, the task assigned to the robot has been completed.

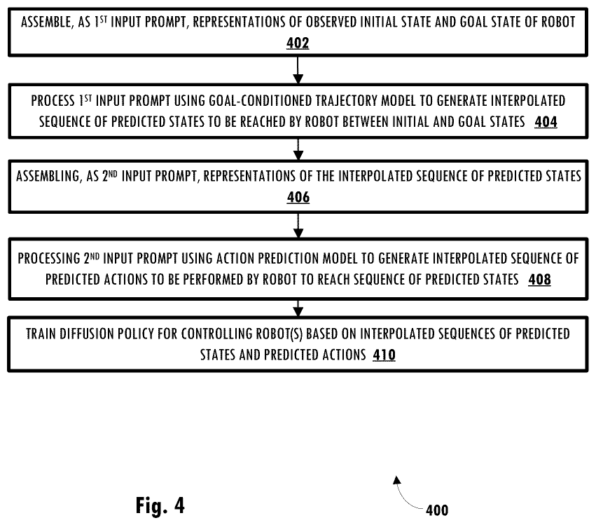

Referring now to FIG. 4, an example method 400 of training a diffusion policy for controlling robot(s) is described. For convenience, the operations of the flowchart are described with reference to a system that performs the operations. This system may include various components of various computer systems, including those depicted in FIG. 1. Moreover, while operations of method 400 are shown in a particular order, this is not meant to be limiting. One or more operations may be reordered, omitted or added.

At blocks 402, the system, e.g., by way of state generator 138, may assemble, as a first input prompt, representations of an observed initial state of a robot and a goal state of the robot. At block 404, the system, e.g., by way of state generator 138, may process the first input prompt using a goal-conditioned trajectory model (e.g., 132) to generate first output indicative of an interpolated sequence of predicted states to be reached by the robot between the observed initial and goal states. The operations of blocks 402-404 may share various characteristics with blocks 306-308 of FIG. 3.

At block 406, system, e.g., by way of state generator 138, may assemble, as a second input prompt, representations of the interpolated sequence of predicted states. At block 408, the system may process the second input prompt using an action prediction model to generate second output indicative of an interpolated sequence of predicted actions to be performed by the robot to reach the interpolated sequence of predicted states. At block 410, the system may train a diffusion policy based on the interpolated sequences of predicted states and predicted actions.

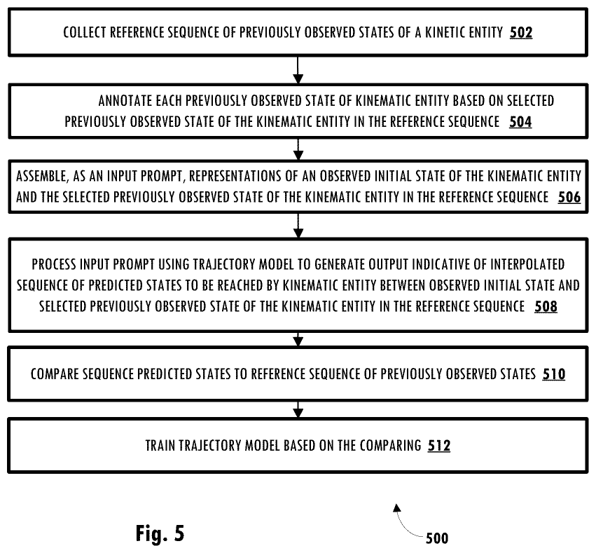

Referring now to FIG. 5, an example method 500 of training a trajectory model using hindsight relabeling is depicted. For convenience, the operations of the flowchart are described with reference to a system that performs the operations. This system may include various components of various computer systems, including those depicted in FIG. 1. Moreover, while operations of method 500 are shown in a particular order, this is not meant to be limiting. One or more operations may be reordered, omitted or added.

At blocks 502, the system may collect a reference sequence of previously observed states of a kinematic entity, such as a robot, person, animal, etc. This reference sequence may take the form of, for instance, a video capturing the kinematic entity in action, an animation or simulation, a trajectory of recorded reference points of the kinematic entity over time, etc.

At block 504, the system may annotate each previously observed state of the kinematic entity based on a selected previously observed state of the kinematic entity in the reference sequence. In some implementations, this selected previously observed state may be a final state of the kinematic entity in the reference sequence, although this is not required.

At block 506, the system may assemble, as an input prompt, representations of an observed initial state of the kinematic entity in the reference sequence and the selected previously observed state of the kinematic entity in the reference sequence. In some implementations, the observed initial state may be a first state of the kinematic entity, but this is not required, and another state of the kinematic entity midstream may be selected instead.

At block 508, the system may process the input prompt using a trajectory model (e.g., 132) to generate output indicative of an interpolated sequence of predicted states to be reached by the kinematic entity between the observed initial state and the selected previously observed state of the kinematic entity in the reference sequence. At block 510, the system may compare the sequence of predicted states to the reference sequence of previously observed states. At block 512, the system may train and/or fine-tune the trajectory model based on the comparing, e.g., using techniques such as cross-entropy, gradient descent, etc.

FIG. 6 is a block diagram of an example computer system 610. Computer system 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computer system 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules described herein. For example, the storage subsystem 624 may include the logic to perform selected aspects of methods 300-500, and/or to implement one or more aspects of the various components depicted in FIG. 1. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a CD-ROM drive, an optical drive, or removable media cartridges. Modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple buses.

Computer system 610 can be of varying types including a workstation, server, computing cluster, blade server, server farm, smart phone, smart watch, smart glasses, set top box, tablet computer, laptop, or any other data processing system or computing device. Due to the ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors and comprising:
assembling, as a first input prompt, representations of an observed initial state of a robot and a goal state of the robot;
processing the first input prompt using a goal-conditioned trajectory model to generate first output indicative of a sequence of predicted states to be reached by the robot between the observed initial and goal states;
assembling, as a second input prompt, representations of the sequence of predicted states; and
processing the second input prompt using an action prediction model to generate second output indicative of a sequence of predicted actions to be performed by the robot to reach the sequence of predicted states.

2. The method of claim 1, further comprising training a diffusion policy for controlling one or more robots based on the sequences of predicted states and predicted actions.

3. The method of claim 1, wherein the goal-conditioned trajectory model is trained using reference sequences of previously observed robot states, wherein for each reference sequence of previously observed robot states, each previously observed robot state is annotated based on a final previously observed robot state of the reference sequence.

4. The method of claim 1, wherein the goal-conditioned trajectory model comprises a diffusion model.

5. The method of claim 1, wherein the goal-conditioned trajectory model comprises a flow model.

6. The method of claim 1, wherein the representation of the goal state of the robot comprises one or more synthetic digital images depicting the goal state.

7. The method of claim 1, wherein the representation of the goal state of the robot comprises a set of reference points on the robot that collectively represent the goal state.

8. The method of claim 1, wherein the representation of the goal state of the robot comprises a representation of the robot itself in the goal state.

9. The method of claim 1, wherein the representation of the goal state of the robot comprises a representation of a human or different robot in a pose that corresponds to the goal state of the robot.

10. The method of claim 1, further comprising:
prior to assembling the first input prompt, assembling, as a third input prompt, representations of the observed initial state of a robot and a task to be performed by the robot;
processing the third input prompt using a generative model to generate the representation of the goal state.

11. The method of claim 1, further comprising generating a control signal for controlling one or more robots based on one or more of the sequence of predicted actions.

12. The method of claim 1, further comprising operating one or more robots based on one or more of the sequence of predicted actions.

13. The method of claim 1, further comprising generating a first control signal for controlling the robot based on a subset of one or more predicted actions selected from the sequence of predicted actions.

14. The method of claim 13, further comprising:
assembling, as a third input prompt, a representation of a subsequent observed state of the robot upon the robot being controlled based on the first control signal;
processing the third input prompt using the goal-conditioned trajectory model to generate third output indicative of a subsequent sequence of predicted states to be reached by the robot after the subsequent observed state;
assembling, as a fourth input prompt, representations of the subsequent sequence of predicted states to be reached by the robot after the subsequent observed state; and
processing the fourth input prompt using the action prediction model to generate fourth output indicative of a subsequent sequence of predicted actions to be performed by the robot to reach the subsequent sequence of predicted states.

15. The method of claim 14, further comprising generating a control signal for controlling the robot based on a new subset of predicted actions selected from the subsequent sequence of predicted actions.

16. The method of claim 14, wherein the fourth input prompt is further assembled to include a representation of the subsequent observed state of the robot upon the robot being controlled based on the first control signal.

17. The method of claim 1, wherein the second input prompt is further assembled to include a representation of the observed initial state of a robot.

18. A method implemented using one or more processors and comprising:
assembling, as a first input prompt, representations of an observed initial state of a robot and a goal state of the robot;
processing the first input prompt using a goal-conditioned trajectory model to generate first output indicative of an interpolated sequence of predicted states to be reached by the robot between the observed initial and goal states;
assembling, as a second input prompt, representations of the interpolated sequence of predicted states; and
processing the second input prompt using an action prediction model to generate second output indicative of an interpolated sequence of predicted actions to be performed by the robot to reach the interpolated sequence of predicted states.

19. The method of claim 18, further comprising training a diffusion policy for controlling one or more robots based on the interpolated sequences of predicted states and predicted actions.

20. A method implemented using one or more processors and comprising:
collecting a reference sequence of previously observed states of a kinematic entity;
annotating each previously observed state of the kinematic entity based on a selected previously observed state of the kinematic entity in the reference sequence;
assembling, as an input prompt, representations of an observed initial state of the kinematic entity and the selected previously observed state of the kinematic entity in the reference sequence;
processing the input prompt using a trajectory model to generate output indicative of an interpolated sequence of predicted states to be reached by the kinematic entity between the observed initial state and the selected previously observed state of the kinematic entity in the reference sequence;
comparing the sequence of predicted states to the reference sequence of previously observed states; and
training the trajectory model based on the comparing.
